(19) United States
(12) Patent Application Publication
(10) Pub. No.: US 2009/0024370 A1
(43) Pub. Date: Jan. 22, 2009

(54) Method and System for Performing T-Spline Based Isogeometric Analysis

(76) Inventors: Michael A. Scott, Pflugerville, TX (US); Thomas J.R. Hughes, Austin, TX (US)

Correspondence Address: DILLON & YUDELL LLP, 8911 NORTH CAPITAL OF TEXAS HWY, SUITE 2110, AUSTIN, TX, 78759, US

(21) Appl. No.: 12/174,971

(22) Filed: Jul. 17, 2008

Related U.S. Application Data
(60) Provisional application No. 60/950,776, filed on Jul. 19, 2007.

(51) Int. Cl. G06F 7/60

(52) U.S. Cl. 703/2

(57) ABSTRACT

A method for performing T-spline based isogeometric analysis is disclosed. An analysis suitable geometry (ASG) description is initially generated from a T-spline surface or volume computer-aid design (CAD) description. Subsequently, a T-spline based isogometric analysis (IGA) code structure that uses the ASG description having ASG analysis ready data is generated.

### PRIORITY CLAIM

The present application claims priority under 35 U.S.C. §119(e)(1) to provisional application No. 60/950,776 filed on Jul. 19, 2007, the contents of which are incorporated herein by reference.

### BACKGROUND OF THE INVENTION

1. Technical Field

The present invention relates to computer-aided design and computer-aided engineering in general, and, in particular, to a method and system for performing T-spline based isogeometric analysis.

2. Description of Related Art

Computer-aided design (CAD) and/or computer-aided manufacturing (CAM) software tools are commonly employed in the process of designing mechanical products and equipments, such as airplanes, ships, cars, etc. Another software tool that is commonly employed in the process of designing mechanical products and equipments is finite element analysis (FEA). Originating in the 1950s, FEA is a powerful computational technique that can be utilized to calculate physical behaviors, such as stress, strain, etc., from a software model without the need of a physical prototype. Today, FEA is typically commercially sold under the tradename computer-aided engineering (CAE).

The first commercially available FEA program appeared in the late 1960s, and by the late 1970s, when commercial CAD programs began to appear, major CAE programs had already mature and their underlying geometric representations were largely defined. Meanwhile, the CAD industry also evolved its own geometric representation, independent of CAE industry. As a result, CAE uses a totally different geometric representation than that of CAD.

Over the years, Non-Uniform Rational B-Spline with trimming curves (also known as trimmed NURBS) emerged as the industry standard free-form surface representation for CAD products, primarily because of its numerous attractive mathematical properties. When a CAD model (generated by a CAD tool) needs to be analyzed by a CAE tool, the CAD model needs to be decomposed into small “finite elements,” such as quadrilaterals and triangles in two-dimension or hexahedra and tetrahedral in three-dimensions. The set of finite elements comprising a CAE model is called a mesh, and the process of converting a CAD model into a finite element model is called mesh generation.

Some types of mesh generation can be performed automatically, but for the most part, mesh generation is a semi-automatic process. Thus, the performance of mesh generation is relatively time-consuming. For example, in the automotive industry, a mesh for an entire vehicle takes about four months to create. It has been reported that approximately 80% of overall design through analysis time is devoted to mesh generation within the automotive, aerospace, and ship-building industries. Such CAD-CAE bottleneck basically translates into lost productivity. Also, since design changes tend to be made on a daily basis, the slow process of mesh generation limits the utility of design and analysis if new meshes cannot be generated within a relatively short time frame. Also, any refinement of a mesh requires communications with a CAD system during each refinement iteration, and such communication link is often unavailable.

Consequently, it would be desirable to provide an improved method and system for performing engineering design and analysis that can dramatically alleviate or even eliminate the above-mentioned CAD-CAE bottleneck.

### SUMMARY OF THE INVENTION

In accordance with a preferred embodiment of the present invention, an analysis suitable geometry (ASG) description is initially generated from a T-spline or volume surface computer-aid design (CAD) description. Subsequently, a T-spline based isogometric analysis (IGA) code structure that uses the ASG description having ASG analysis ready data is generated. Finite element analysis can be readily performed on the T-spline based IGA code structure.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high-level logic flow diagram of a method for performing T-spline based isogeometric analysis, in accordance with a preferred embodiment of the present invention; and

FIG. 2 is a block diagram of a computer system in which a preferred embodiment of the present invention is incorporated.

### DETAILED DESCRIPTION OF A PREFERRED EMBODIMENT

I. Introduction

T-spline based isogeometric analysis grew out of an effort to address fundamental problems facing the engineering design through analysis (DTA) communities. Engineering designs or computer-aided designs (CAD) rely heavily on Non-Uniform Rational B-splines (NURBS) to describe geometry. The underlying rectangular topology of a single NURBS patch limits its ability to represent objects of complicated topology.

Attempts to overcome this limitation have resulted in complicated schemes for merging and intersecting many patches while maintaining a visually pleasing result. Unfortunately, the underlying mathematics do not support these endeavors and a proliferation of geometric inconsistencies result from the process. However, these small inconsistencies wreak havoc on downstream analysis applications. Most notably, gaps and overlaps existing in complex models must be resolved to ensure that a valid finite element mesh can be generated. Solutions to this problem are semi-automatic at best and do not scale well with increasing model complexity.

In the traditional DTA process, the mesh is the analysis suitable geometry (ASG). ASG can be defined broadly as a geometric description whose underlying functional representation (basis) can be extracted and used in computations without modification. Generally, once the meshing step is completed, a C⁰ polynomial basis is constructed over the mesh. Essentially this means a C⁰ polynomial spline is generated over the mesh. When viewed from the standpoint of CAD, this is a severe loss in accuracy. In the original CAD geometry, each NURBS was most likely C⁰. Even with a well formed mesh, this loss in geometric accuracy can create errors in analytical results. The following examples may be mentioned: shell buckling analysis is very sensitive to geometric imperfections, boundary layer phenomena and lift and drag are sensitive to precise geometry of aerodynamic and hydrodynamic configurations, and sliding contact between bodies cannot be accurately represented without precise geometric descriptions.

In most cases, the traditional ASG is disconnected from the CAD geometry that originally defined it. This incompatibility precludes or greatly inhibits the adoption and development of technology where tight integration of the overall DTA process is required. Fundamental technologies like automatic adaptive mesh refinement have not been widely adopted in industry because mesh refinement requires access to the exact geometry, and thus it also requires seamless and automatic communication with CAD, which simply does not exist in practice. Without accurate geometry and mesh adaptivity, convergence and high-precision results are impossible.

Important pace setting technologies such as shape optimization, verification and validation (V&V), uncertainty quantification (UQ), and petascale computing are also greatly hampered by this lack of integration. Shape optimization requires that the CAD geometry-to-mesh mapping be automatic, differentiable and tightly integrated with the solver and optimizer. This is simply not the case as meshes are disconnected from the CAD geometries from which they were generated. V&V requires error estimation and adaptivity, which in turn requires tight integration of CAD, geometry, meshing, and analysis. UQ requires simulations with numerous samples of models needed to characterize probability distributions. Sampling puts a premium on the ability to rapidly generate geometry models, meshes, and analyses, which again leads to the need for tightly integrated geometry, meshing, and analysis. The era of petaflop computing is on the horizon. Parallelism keeps increasing, but the largest unstructured mesh simulations have stalled because no one truly knows how to generate and adapt massive meshes that keep up with increasing concurrence. To be able to capitalize on the era of O(10⁵) core parallel systems, CAD, geometry, meshing, analysis, adaptivity, and visualization all have to run in a tightly integrated way, in parallel and scalably.

The present invention provides a T-spline and T-NURCC based isogeometric analysis method as a viable alternative to traditional DTA approaches. For the present disclosure, T-splines and T-NURCCs are defined as surface (bivariable) or volumetric (trivariable) CAD descriptions, and such surface descriptions overcome the limitations inherent in NURBS. Isogeometric analysis is defined as an engineering analysis framework based on exact CAD representations.

### II. Background

### 2.1 Notation

The following numbering scheme is chosen for the present disclosure:
1. ε—numbering of IGA finite elements;
2. A,B—Global numbering of T-spline basis functions;
3. a,b—Local numbering of the spanning set of T-spline basis functions for a particular IGA element E_{ε}; and
4. α,β—Local numbering of the Bernstein basis for a particular IGA element E_{ε}.

The following quantities whose significance will become apparent later are defined as:
1. nₑₗ—Number of IGA finite elements;
2. n_{g}^{ts}—Number of T-spline basis functions;
3. nₗ^{ts}—Number of T-spline basis functions in the spanning set for a particular IGA element E_{ε};
4. n_{g}^{bb}—Number of Bernstein basis functions;
5. nₗ^{bb}—Number of Bernstein basis functions in the spanning set for a particular IGA element E_{ε};
6. n_{dir}—The number of T-spline basis functions assigned essential boundary condition data; and
7. n_{eq}—The number of global equations. This number is computed as n_{eq}=n_{g}^{ts}−n_{dir}.
   Note that g denotes global and l denotes local.

### 2.2 T-Splines and T-NURCCs

T-splines and T-NURCCs overcome many of the limitations inherent in NURBS. Most significantly, they permit T-junctions. In a practical sense, T-junctions allow for rows of control points or basis functions to terminate. This relaxes the tensor product constraint present in a NURBS. Non-Uniform Rational Catmull-Clark surfaces with T-junctions (T-NURCCs) are a generalization of both Catmull-Clark and T-spline surfaces. They allow for non-uniform local refinement of Catmull-Clark surfaces and can represent arbitrary topological domains. In this work, cubic T-NURCC surfaces are utilized and a generalization of cubic T-spline surfaces to the trivariate case with arbitrary polynomial order.

T-splines and T-NURRCs allow the building of bases that are complete up to a desired polynomial order, as smooth as an equivalent NURBS basis, and are capable of being locally refined while keeping the original geometry and parameterization unchanged. It should be noted that the properties that make T-splines and T-NURCCs useful for geometric modeling also make them useful for isogeometric analysis.

### 2.3 T-Spline Basis Functions

To define a T-spline basis function R_{A}^{ts}, a local knot vector structure is initially defined. Let Ξ_{A} denote the local knot vector structure for the T-spline basis function R_{A}^{ts} such that

Ξ_{A}={Ξ_{A}ⁱ}ᵢ₌₁^{d}

where

Ξ_{A}ⁱ={ξⱼⁱ}ⱼ₌₁^{p}^{ᵢ}⁺²

and d is the number of spatial dimensions and pᵢ is the local polynomial order in the i^{th} direction. Using Ξ_{A}, a multivariate B-spline basis function may be constructed as

$${N}_{A} ( ξ ) = {\prod }_{i = 1}^{d} {N}_{a}^{i} ( {ξ}^{i} ) \qquad {ξ}^{i} ∈ {Ξ}_{A}^{i}$$

Now as is common, a geometric coefficient P_{A}^{ts} is associated with the structures generated above. It is further assumed that a weighing w_{A} is associated with each control point. These coefficients are commonly called “control points.” The T-spline basis function can then be defined as

$${R}_{A}^{ts} ( ξ ) = \frac{{w}_{A} {N}_{A} ( ξ )}{{\sum }_{B = 1}^{{n}_{g}^{ts}} {w}_{B} {N}_{B} ( ξ )}$$

It should be noted that these definitions are independent of a particular global mesh structure. The interaction of T-spline basis functions is defined by a T-mesh.

### 2.4 T-Spline Definition

Given the sets

$${\{ {R}_{A}^{ts} \}}_{A = 1}^{{n}_{g}^{ts}} and {\{ {P}_{A}^{ts} \}}_{A = 1}^{{n}_{g}^{ts}} ,$$

a T-spline can be defined as

$$t ( ξ ) = {\sum }_{i = 0}^{{n}_{g}^{ts}} {P}_{A}^{ts} {R}_{A}^{ts} ( ξ )$$

### 2.5 T-Mesh

A T-mesh defines the way T-spline basis functions interact and preserves the nice mathematical properties present in NURBS. It is a non-hierarchical approach that is especially convenient for design. It allows for local refinement by introducing T junctions. The T-mesh encodes a topology and parameterization for the entire T-spline. The parameterization is defined in terms of knot intervals which are assigned to the underlying topology of the T-mesh. Knot intervals extend the concept of parameterization to an arbitrary topological setting. In essence, they localize the parameterization to a neighborhood of each control point or basis function.

2.6 Inferring Basis Functions from a T-Mesh

In a traditional NURBS setting, global knot vectors are used to define a complete set of basis functions. For T-splines, each basis function is defined by a local knot vector structure Ξ_{A}. Each local knot vector Ξ_{A}ⁱ is inferred from the T-mesh. Inferring these local structures is the most fundamental operation performed on a T-mesh.

The T-mesh under consideration is assumed to be valid. A correlation between topological entities in the T-mesh and the basis functions are first generated. These entities are chosen to correspond to the point of symmetry of the underlying basis function. Note that this is similar to traditional finite elements where, because of the interpolatory nature of the underlying finite element basis, nodes are often used to represent the underlying basis function.

For ease of exposition we will only consider surfaces. The generalization to volumes is straightforward once the surface case is understood. The odd and even polynomial orders should be considered separately since the points of symmetry of the underlying basis functions are associated with different topological entities in the T-mesh. In the surface case the underlying basis functions are defined by two local knot vectors, Ξ_{A}¹ and Ξ_{A}².

### 2.6.1 Complete Odd Polynomial Order

In this case, the polynomial orders p₁ and p₂ of both local knot vectors is odd. Control points in the T-mesh are associated to each complete odd polynomial ordered basis function. To infer the local knot vector structure for a complete odd basis function, the parameterization is inferred from a local neighborhood of the corresponding control point in the T-mesh. Performing topological operations on the mesh, each topological direction is searched until [p+1]/2 edges are found. These edges must be perpendicular to the search direction. Since each entity in the mesh carries knot interval information it is easy to infer the local knot vector structure. If convenient, affine rescalings may be performed to the knot vectors without changing the basis function or surface.

### 2.6.2 Mixed Polynomial Order

In this case, the polynomial order of one local knot vector is odd while the other is even. Edges in the T-mesh are associated to each mixed polynomial ordered basis function. The function is anchored to the center of the edge for convenience. To infer the local knot vector we proceed as explained in Section 2.6.1. In this case, p/2+1 topological edges are searched for in the even direction, not including the associated edge. The odd search process remains the same.

### 2.6.3 Complete Even Polynomial Order

In this case, the polynomial order of both local knot vectors is even. Faces in the T-mesh are associated to each complete even polynomial ordered basis function. As above, the function is anchored to the center of the face. The process is the same as above except p/2+1 edges are searched for in each direction.

### 2.7 Local T-Spline Basis Function Subdivision and Exact Refinement

An extremely important operation is the exact subdivision of T-spline basis functions. This can also be considered exact local refinement when the resulting geometric description is of interest. This idea permeates all the developments that follow. For ease of exposition, the one dimensional case will only be considered. Extensions to the multivariate case are straightforward. Consider a one-dimensional cubic T-spline basis function R_{A}^{ts}(ξ). The length of the local knot vector governing its definition has p+2 knots where p=3 in this case. Let Ξ_{A}¹={ξ₁¹, ξ₂¹, ξ₃¹, ξ₄¹, ξ₅¹}. Now, if an additional knot ξ̅ is added such that Ξ_{A}¹={ξ₁¹, ξ₂¹, ξ₃¹, ξ₄¹, ξ₅¹}, it can be shown that

R_{A}^{ts}(ξ)=c₁ R̅₁̅¹̅(ξ)+c₂ R̅_̅{̅A̅}̅²̅(ξ)

where the local knot vectors defining R̅_{A1}(ξ) and R̅_{A}₂(ξ) are {ξ₁¹, ξ₂¹, ξ̅, ξ₃¹, ξ₄¹} and {ξ₂¹, ξ̅, ξ₃¹, ξ₄¹, ξ₅¹}, respectively. It should be noted that the coefficients c₁ and c₂ can be easily derived by treating R_{A}^{ts}(ξ) as a T-spline and using polar form methods. If an exact update of the geometry is desired these coefficients can be used to update the control points of the refined geometry. It should be noted that if the inserted knot duplicates an existing knot in the knot vector than the continuity is decreased along that knot line. It should be noted that when exact non-hierarchical local refinement is required in two or three dimensions an iterative algorithm should be used. The iterative algorithm should generalize the ideas presented here and resolves all topological and functional conflicts as refinement progresses such that the exact geometry is preserved and all functions remain on a single level.

### 2.8 T-Spline Volumes

As mentioned before, the original cubic T-spline surface (bivariate) definition is generalized to the volumetric (trivariate) arbitrary polynomial order case. The local non-hierarchical refinement capability of cubic T-spline surfaces can also be generalized to this general setting. This extension is greatly complicated due to the extremely unstructured nature of a T-spline volume. A T-mesh is defined in three dimensions as a topological arrangement of hexahedral elements. As before, T-junctions are also allowed in any legal position. Topological entities still carry knot interval information. The extraction of local knot vectors, and in turn, basis functions, is similar from a conceptual standpoint to the two-dimensional case. Additional complexity emanates from the complicated topological constructs (mesh) required to ensure an accurate and computationally efficient representation of the T-mesh. The implementational details will not be described in the present disclosure. The generalization of the complete odd, mixed and complete even cases described in Section 2.6 to the appropriate topological entities in the volumetric setting should be straightforward. Thus, local knot vector structures, corresponding T-spline basis functions, and the volumetric T-spline definition follow in much the same way as for surfaces.

### 2.9 T-NURCCs

T-NURCCs generalize non-uniform cubic B-spline surfaces to control grids of arbitrary topology. Thus, T-NURCCs also generalize Catmull-Clark surfaces to non-uniform knot vectors. In addition, they allow T-junctions which makes them locally refineable. Thus, T-NURCCs can equivalently be viewed as a generalization of T-splines to T-meshes of arbitrary topology. A convenient conceptual way to view a T-NURCC is as a collection of T-splines whose overall topological configuration may be unstructured. When multiple T-splines meet, if the valence of the point where they meet is not four, an extraordinary point is generated. The two-ring neighborhood of this extraordinary point constitutes a limit or subdivision surface. A unique and important property of T-NURCCs is that refinement in the neighborhood of the extraordinary point remains local. Since, in the neighborhood of an extraordinary point the surface is defined in the limit, an approximation to the surface must be made. Of practical significance here is that these approximations yield a Bézier decomposition which can be treated identically to the Bézier decomposition in the regular regions of the surface.

III. Generating a T-Spline or T-NURCC Based Analysis Suitable Geometry from a T-Spline or T-NURCC Surface or Volume

### 3.1 Overview

After the creation of a T-spline or T-NURCC CAD description, the next step in T-spline based isogeometric analysis is the generation of analysis suitable geometry from the CAD description. Analysis suitable geometry (ASG) can be defined broadly as a geometric description whose underlying functional representation (basis) can be extracted and used in computations without modification. A T-spline CAD description is a bivariate (surface) or trivariate (volume) description of the geometry. Since these descriptions are often created without explicit knowledge of the requirements of downstream analysis applications, the CAD description often must be modified such that analysis applications can interface with it. On a high level, this transformation ensures that the underlying functional representation (basis) of the T-spline CAD description is tailored for use in IGA.

3.2 Conversion of T-Spline CAD Descriptions into ASG

The native properties of T-splines and T-NURCCs obviate many translation and interface issues that arise in NURBS based systems. However, the specific application of interest and the computing environment of the IGA may require additional tailoring. Several general operations have emerged which should always be considered when generating T-spline based ASG. The most important considerations are described here.

### 3.2.1 Boundary Interpolation

For ease of use in Isogeometric analysis it is highly desirable that ASG accommodate the efficient application of boundary conditions. This is especially important when dealing with essential boundary conditions which are built into the function spaces being used. To create a simple interface for the application of essential and natural boundary conditions T-spline based ASG should allow for interpolatory end conditions. This generates geometry which is interpolatory at all boundaries. Thus, applying essential boundary conditions in this setting is identical to applying them to interpolatory finite elements in traditional approaches. Control points simply take the place of nodes.

In the context of an unstructured T-spline or T-NURCC representation of the geometry this process can be viewed as an operation on T-spline basis functions. The first step is to identify all the basis functions whose support includes the boundary of the geometry. Then repeated exact local refinement is performed on those functions in a manner that C⁰ continuity is achieved along the boundary. The operation will force the resulting geometry to interpolate the boundary.

3.2.2 Explosion into NURBS Patches

T-splines can be converted into a corresponding set of NURBS patches automatically. From a computational standpoint, this may be desirable. The tensor product structure of NURBS patches is efficient. Computing with sets of NURBS patches is also easily parallelized.

The extraction of NURBS patches begins by identifying the regular regions of a T-NURCC. Each regular region will be a well formed T-spline. All T-junctions are extended through their corresponding region. This is again performed by exact local refinement in the regular T-spline regions. With the extension operation complete each regular region is now a tensor product NURBS.

If two regular regions share a border, the local nature of a T-spline allows for the extension operation of each region to terminate at the shared boundary. Thus knot lines need not proliferate through the whole domain. Thus each region is a NURBS but all borders retain a T-spline structure. If further decomposition is desired the regions may be decoupled by creating C⁰ continuity lines along all borders. Global border restriction operators may be formed which govern the continuity structure along shared borders. These border restriction operators can be formed by performing controlled function subdivision (see Section 2.7) where only T-spline basis functions spanning the borders of interest are decomposed.

IV. Transforming ASG into ASG Analysis Ready Data

### 4.1 Overview

In Section 3.1, the process of tailoring the basis of a specific T-spline or T-NURCC CAD description is explained so that it becomes a suitable ASG basis. This process may enrich the basis and even alter the geometry to within an acceptable tolerance. In this section, an exact transformation of the basis is performed to greatly expedite computational implementation in an IGA framework. This process represents a transformation from “native geometric ASG data” into “ASG analysis ready data.” This transformation is lossless. In other words, the exact geometric functional representation is maintained throughout. Also, these steps are automatic and emanate from the underlying structure present in T-spline or T-NURCC geometry. Further, a more traditional element centric point of view is taken in the present disclosure. Abstractly, the native geometric data includes:
1. Geometric basis;
ii. Geometric coefficients; and
iii. Underlying topology (T-mesh) of the ASG.
   This is transformed into analysis ready data that includes:
i. A partitioning of the ASG into elements;
ii. An exact transformation of the original geometric basis into a computationally convenient basis;
iii. An exact transformation of the original geometric coefficients into a computationally convenient set of geometric coefficients; and
iv. The operator emanating from this exact transformation.

It should be noted that there is many possible instantiations of the abstractions stated above. The most general and obvious is allowing the transformation to be the identity. Then the basis is not transformed in any way. However, computing with the T-spline or T-NURCC basis directly is very inefficient when compared to computing with the Bernstein basis over discrete elements. Also, without any transformation, automatically discretizing the geometry into regions where Gaussian quadrature can be performed is difficult to automate and computationally inefficient in the general trivariate T-NURCC case. The Bézier decomposition (presented below) on the other hand is automatic and scales with geometric complexity. Further, once the transformation is complete, the link with the CAD description may be severed. All the information required by downstream analysis applications is encapsulated exactly in the analysis ready data. This encapsulation property is remarkable when viewed in terms of the geometric sophistication of a general T-NURCC CAD description. Also, the look and feel of the information generated by the Bézier decomposition is almost identical to what you would expect in traditional finite elements. Thus, the ease of adoption of this approach in existing finite element codes is greatly amplified. Thus, the approach presented in the present disclosure is a good balance between generality, computational efficiency, and ease of adoption.

### 4.2 Extraction of Coarse Scale Geometric Basis

The most basic information that must be extracted from the governing T-mesh is the T-spline or T-NURCC basis functions

$${\{ {R}_{A}^{ts} \}}_{A = 1}^{{n}_{g}^{ts}} .$$

These functions were defined in Section 2.3. Also, since the geometry needs to be represented exactly at the coarsest level, the control points

$${\{ {P}_{A}^{ts} \}}_{A = 1}^{{n}_{g}^{ts}}$$

are extracted. Then, as explained in Section 2.4, the T-spline can be written as

$$T ( ξ ) = {\sum }_{A = 1}^{{n}_{g}^{ts}} {P}_{A}^{ts} {R}_{A}^{ts} ( ξ )$$

The process of extracting T-spline basis functions is described in detail in Section 2.6. It is noted that at the conclusion of this step, the exact geometric mapping that governs the original T-spline or T-NURCC CAD description is extracted.

### 4.3 Generation of Geometric Discretization

T-splines can represent arbitrary topological domains. The composition of the control mesh may be very unstructured. Understanding the continuity of the geometry is critical for accurate computations. A method that automatically generates a minimal discretization along all lines of continuity is presented. In addition, this discretization generates an operator C that can be used to create an efficient IGA finite element.

4.3.1 Bézier Extraction

Given a T-spline, the first step in generating IGA elements is to extract all the Bézier patches which define the geometry. This set of patches is denoted as {E_{ε}}_{ε=1}ⁿ^{ₑₗ}. To accomplish this, each T-spline basis function R_{A}^{ts}, A=1,2, . . . , n_{g}^{ts} is converted into its Bézier representation. This is accomplished through local function subdivision such that a new C⁰ basis is derived. This C⁰ basis corresponds exactly to a B6zier representation over each C^{oo} patch in the geometry. This can be viewed as a global change of basis from {R_{A}^{ts}}_{A=1}ⁿ^{_{g}}^{^{ts}} to a Bernstein basis {B_{A}^{ts}}_{A=1}ⁿ^{_{g}}^{^{bb}} such that

R=CB

Here C can be viewed as a restriction operator from the space spanned by the Bernstein basis to the original T-spline space spanned by the original basis. The control points are also generated for this new Bernstein basis by noticing that

$$\begin{matrix}T ( ξ ) = ( {P}^{ts} ) R ( ξ ) \\ = {( {P}^{ts} )}^{T} ℂ B ( ξ ) \\ = ( {( {P}^{ts} )}^{T} ℂ ) B ( ξ ) \\ = {( {P}^{bb} )}^{T} B ( ξ )\end{matrix}$$

which implies that P^{bb}=C^{T}P^{ts}. The transpose of the restriction operator can be utilized to generate the new control points corresponding to the Bernstein basis. These new control points preserve the exact geometry.

### 4.4 Generation of the IGA Finite Element

Up to this point, the extraction process is viewed as a global operation. These same quantities can also be defined locally over each patch.

### 4.4.1 IGA Element Definition

It is assumed that a set of B6zier patches which have been defined through the extraction process described earlier. With each patch E_{ε}, the following quantities can be defined:

i. Spanning set of T-spline basis functions

$${\{ {R}_{a}^{ε} \}}_{a = 1}^{{n}_{l}^{ts}}$$

This set includes all the T-spline basis functions whose support contain this element. These lists are generated automatically during the Bézier extraction process.

ii. Spanning set of T-spline control points

$${\{ {P}_{a}^{ε , ts} \}}_{a = 1}^{{n}_{l}^{ts}}$$

These are simply the control points which correspond to the basis functions in the spanning set of T-spline basis functions.

iii. Spanning set of Bernstein basis functions

$${\{ {B}_{α}^{ε} \}}_{α = 1}^{{n}_{l}^{bb}}$$

This is the set of Bernstein basis functions whose support contain this element. These are also generated automatically during the Bézier extraction process.

iv. Spanning set of Bernstein control points

$${\{ {P}_{α}^{ε , bb} \}}_{α = 1}^{{n}_{l}^{bb}}$$

These are computed using the transpose of the element restriction operator

P_{ε}^{bb}(C^{ε})^{T}P_{ε}^{ts}

V. Element restriction operator C^{ε}
As defined previously, the global restriction operator C governs the change of basis between the T-spline basis and the Bernstein basis that has been using over each element. The generation of the element restriction operator can be viewed as a partitioning of the global restriction operator C such that C^{ε} contains only those rows and columns corresponding to the non-zero T-spline and Bernstein basis functions over the element E_{ε}. Thus, the element restriction operator performs the same action as its global counterpart on an element level. Each Bézier patch, along with this additional information defines an IGA finite element.

### V. Use ASG Analysis Ready Data in a T-Spline Based IGA Code Structure

With ASG analysis ready data, a T-spline based isogeometric analysis code structure can be constructed for computation.

### 5.1 Overview

When solving boundary value problems using finite element methods, the original infinite dimensional approximation spaces are replaced by finite dimensional spaces. Further, the domain is discretized into finite elements over which the finite dimensional basis is defined. This construction leads to a coupled algebraic sparse system of equations which can be solved on a computer system. In T-spline based isogeometric analysis the basis for the finite dimensional approximation spaces are the functional basis of the ASG which originated from a T-spline or T-NURCC CAD description. Thus, the exact geometry is represented in the analysis at the coarsest level. This is a distinguishing characteristic of T-spline based Isogeometric Analysis and differentiates it from other, more traditional, finite element methods.

### 5.2 IGA Computational Framework

The implementational details for T-spline based isogeometric analysis is described. If the identity operator was chosen instead of the operator C, the T-spline or T-NURCC basis should be used directly. Of course, an appropriate element would have to be defined where Gaussian quadrature could be performed. In addition, evaluations would use the T-spline basis function directly. This makes the identity operator approach very inefficient when compared to the C operator approach described here. For the rest of the disclosure, C is assumed to have been calculated.

### 5.3 Element Stiffness Matrices and Force Vectors

Similar to traditional finite element approaches, in T-spline based Isogeometric analysis we define element stiffness matrices and force vectors, k^{ts,ε}, k^{bb,ε} and f^{ts,ε}, f^{bb,ε}

where

k^{ts,ε}=[k_{ab}^{ts,ε}]

k^{bb,ε}=[k_{α,β}^{bb,ε}]

f^{ts,ε}=[f_{α}^{ts,ε}]

f^{bb,ε}=[f_{α}^{bb,ε}]

These element stiffness matrices and force vectors are defined in terms of the local T-spline and Bernstein basis function numbering. By using the element restriction operator C^{ε}, k^{ts,ε} can be related to k^{bb,ε} and f^{ts,ε} can be related to f^{bb,ε} by

k^{ts,ε}=C^{ε}k^{bb,ε}(C^{ε})^{T}

f^{ts,ε}=C^{ε}f^{bb,ε}

A simple assembly procedure can then be performed such that the terms in k^{ts,ε} and f^{ts,ε} are placed in appropriate locations in the global stiffness matrix and force vector.

### 5.4 Shape Function Subroutines

One of the advantages of extracting IGA finite elements from ASG is that it generates a “parent” element where local Bernstein basis function quantities can be computed once for the element group. This creates a computational element structure that is almost identical to the element structure found in traditional finite element methods. The differences are noted in the sections which follow.

### 5.4.1 Computing Local Quantities

If the global T-spline basis functions are rational in physical space than the Bernstein basis functions will also be rational in physical space. This implies that if local quantities need to be compute once for the element group, those quantities must be computed using the basis in real projective space where the basis functions are polynomials. Standard methods may then be used for computing the required local quantities.

### 5.4.2 Computing Global Quantities

When computing global quantities such as gradients with respect to physical coordinates and Jacobian determinants at each Gauss point the rational Bernstein basis functions must first be formed. This is done simply by computing the weighing w(ξ) and dividing through by it. It should be noted that the weighing w(ξ) remains invariant throughout the Bézier extraction process. Thus, w(ξ) can be viewed as a field emanating from the geometry. Thus, if the basis is rational, w(ξ) may differ from one from point to point in the geometry. This is why it must be computed at each Gauss point for each element in the group.

### 5.5 Adaptive Refinement

If a global or local adaptive refinement procedure is requested it can be incorporated simply. If a non-hierarchical scheme is desired which must preserve the exact geometry, then local T-spline refinement can be incorporated. If a hierarchical refinement scheme is preferred instead, then the space can be enriched with additional T-spline basis functions which possess a specified continuity compatibility with the original or coarse scale basis functions. Either approach will require a refined IGA element set. This can be performed simply, efficiently, and locally by splitting the underlying Bézier patches using common techniques from Computer-aided Geometric Design (CAGD). The only additional requirement for non-hierarchical schemes is the preservation of linear independence.

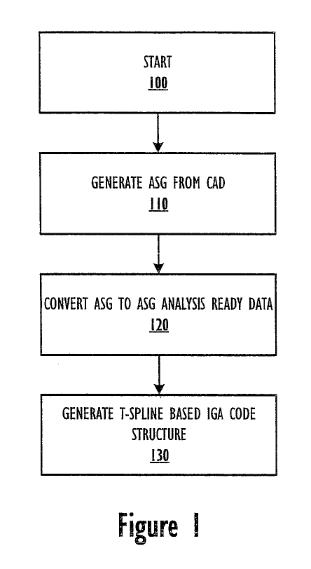

Referring now to the drawings and in particular to FIG. 1, there is depicted a high-level logic flow diagram of a method for performing T-spline based isogeometric analysis, in accordance with a preferred embodiment of the present invention. Starting at block 100, an ASG file is generated from a T-spline surface or volume CAD description, as shown in block 110. The ASG file is then converted into ASG analysis ready data, as depicted in block 120. A T-spline based IGA code structure that uses the ASG file having the ASG analysis ready data is generated, as shown in block 130.

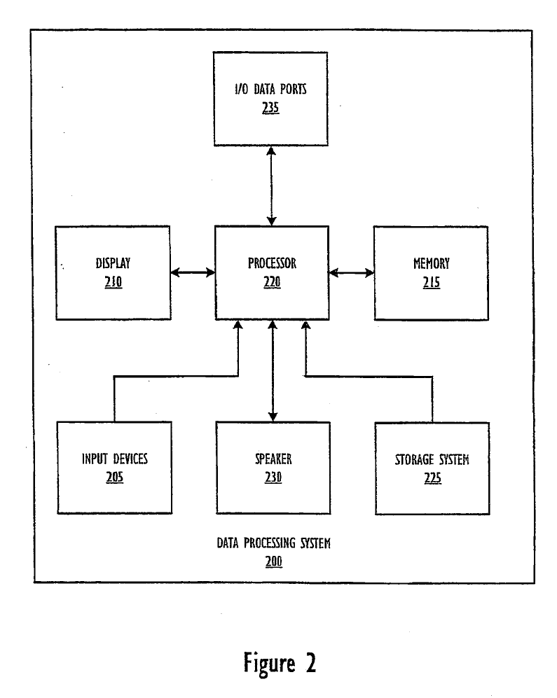

With reference now to FIG. 2, there is depicted a block diagram of a computer system in which a preferred embodiment of the present invention is incorporated. As shown, a computer system 200 includes input devices 205, such as a keyboard and a mouse, and output devices, such as a display 210 and speaker 230, connected to a processor 220. Computer system 200 also includes a storage system 225 such as a hard drive for storing data and instructions to be processed by processor 220. Coupled to processor 220, input/output (I/O) port 235 may be utilized to transfer information between computer system 200 and another computer system or a network.

As has been described, the present invention provides a method and system for performing T-spline based isogeometric analysis.

It is also important to note that although the present invention has been described in the context of a computer system, those skilled in the art will appreciate that the mechanisms of the present invention are capable of being distributed as a program product in a computer readable storage medium.

While the invention has been particularly shown and described with reference to a preferred embodiment, it will be understood by those skilled in the art that various changes in form and detail may be made therein without departing from the spirit and scope of the invention.

What is claimed is:

1. A method for performing T-spline based isogeometric analysis, said method comprising:
generating an analysis suitable geometry (ASG) description from a T-spline surface or volume computer-aid design (CAD) description; and
generating a T-spline based isogometric analysis (IGA) code structure that uses said ASG description having ASG analysis ready data.

2. The method of claim 1, wherein said generating said ASG description further includes forcing said T-spline surface or volume CAD description to interpolate its boundary or extracting said T-spline surface or volume CAD description into NURBS patches.

3. The method of claim 1, said method further includes converting said ASG description to said ASG analysis ready data using Bézier extraction.

4. A computer readable medium having a computer program product for performing T-spline based isogeometric analysis, said computer readable medium comprising:
program code for generating an analysis suitable geometry (ASG) description from a T-spline surface or volume computer-aid design (CAD) description; and
program code for generating a T-spline based isogometric analysis (IGA) code structure that uses said ASG description having ASG analysis ready data.

5. The computer readable medium of claim 4, wherein said program code for generating said ASG description further includes program code for forcing said T-spline surface or volume CAD description to interpolate its boundary or program code for extracting said T-spline surface or volume CAD description into NURBS patches.

6. The computer readable medium of claim 4, said computer readable medium further includes program code for converting said ASG description to said ASG analysis ready data using Bézier extraction.

7. A computer system for performing T-spline based isogeometric analysis, said computer system comprising:
means for generating an analysis suitable geometry (ASG) description from a T-spline surface or volume computer-aid design (CAD) description; and
means for generating a T-spline based isogometric analysis (IGA) code structure that uses said ASG description having ASG analysis ready data.

8. The computer system of claim 7, wherein said means for generating said ASG description further includes means for forcing said T-spline surface or volume CAD description to interpolate its boundary or means for extracting said T-spline surface or volume CAD description into NURBS patches.

9. The computer system of claim 7, said computer system further includes means for converting said ASG description to said ASG analysis ready data using Bézier extraction.
